(19) United States
(12) Patent Application Publication
(10) Pub. No.: US 2006/0099421 A1
(43) Pub. Date: May 11, 2006

(54) High specific surface area composite alumina powder with thermal resistance and method for producing the same

(75) Inventors: Fu-Su Yen, Tainan City (TW); Tien-Chun Lin, Taichung City (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: NATIONAL CHENG KUNG UNIVERSITY, TAINAN CITY (TW)

(21) Appl. No.: 11/103,517

(22) Filed: Apr. 12, 2005

(30) Foreign Application Priority Data
Nov. 11, 2004 (TW) 93134530

(51) Int. Cl. C01F 7/02; B32B 5/16

(52) U.S. Cl. 428/403; 423/625

(57) ABSTRACT

A composite alumina powder with thermal resistance and high specific surface area and a method for producing the same are disclosed. The composite alumina powder is mixed with multi-phase alumina powders for raising the temperature of phase transformation, so as to maintain its high specific surface area when suffering high temperatures for a long time. Therefore, as the composite alumina powder of the present invention is applied as a high temperature catalytic material, it provides high specific surface area required of the catalysis, prolongs its lifetime, and reduces the amounts of noble metals used as well, resulting in great reduction of cost.

### CROSS REFERENCE

This application claims priority of Taiwanese Patent Application No. 93134530, filed on Nov. 11, 2004, which is hereby incorporated by reference.

### FIELD OF THE INVENTION

The present invention relates to a composite alumina powder and a method for producing the same, and more particularly, to a high specific surface area composite alumina powder with thermal resistance and a method for producing the same.

### BACKGROUND OF THE INVENTION

The need for special ceramic materials is steadily increasing all over the world. Among these materials, alumina exhibits some of the most superior properties of all ceramic materials: for example, high melting point and excellent wear resistance, insulation, mechanical strength and chemical stability. Thus, alumina has become one of the most popular ceramic materials in a diverse array of applications. Furthermore, alumina is easily obtained and the processing technique for making it is standardized, so it has been employed from the 1900's in the large-scale production of high-temperature refractories, insulating materials, grinding media, cutting tools, spark plugs, integrated circuit (IC) substrates, artificial tooth implants, high-voltage sodium lamps with light perviousness, catalytic materials, composite materials in dispersion phase and so on. Consequently, alumina has become one of the materials required in the processes of light and heavy industries.

The production of alumina powder having high specific surface area, which is commonly applied as a desiccants and an adsorbent for gases and organic fluids, began from the 1930's, when it was also called activated alumina. Moreover, the alumina powder having high specific surface area is applied in separating components of chemical engineering processes and treating water. Owing to alumina having chemically and thermally stable properties, the gibbsite or boehmite obtained in the Bayer process undergoes a thermal treatment for forming α-phase alumina, and various alumina transition phases, such as κ-phase, θ-phase, δ-phase and γ-phase, which are derived from the formation process of the α-phase alumina, have also become the most popular catalytic materials or catalyst carriers applied in the chemical industry. At present, alumina material serving as a catalyst can be a film coated on the surface of the carrier (such as in a catalytic converter of a car), or it can also be a sphere, a cylinder, a flake or other shape, depending on the actual requirement.

It is a need to develop alumina powders with high specific surface area that can be resistant to higher temperature environment (above 900° C.), for example, that can be used for automotive emission control systems. Monolithic catalyst systems consisting of a cellular ceramic coated with high surface area (y-) alumina and noble metal catalysts are now widely used. The catalyst system was developed in the early 1970 and commercially utilized starting with 1975 model-year cars in US based on the Clean Air Act of 1970. For this reason, the industry at that time was required to more exactly control the engine design and the fuel/air ratio during exploring the power fuel. Moreover, a system for treating exhaust gases was further disposed on the exhaust pipe connected with the engine, for treating the exhaust gases before exhausting, so as to reduce the amount of harmful gases. The above system for treating exhaust gases is now called the “catalytic converter”. Presently, the sales income of catalytic converters is more than ten billion US dollars per year. In the typical process, the honeycomb-like porous monolithic carrier, which is the cordierite-based material, is firstly produced, and then the pore walls of the carrier are coated with a film that contains noble metal micro-particles of palladium (Pd), platinum (Pt) and rhodium (Rh) in γ-phase, δ-phase and θ-phase alumina, for example. The transition alumina phases are obtained by thermally treating boehmite, and they serve as the carriers for the catalytic material of Pd, Pt and Rh metal micro-particles. In addition, because of increasing environmental protection requirements and more stringent regulations for reducing harmful gases, the functional requirements for catalytic converters of exhaust gases is also increasing.

With 2005 as the deadline, there is an essential need for obtaining a material for converting automobile exhaust that can be maintained at the desired high specific surface area when suffering higher temperatures such as 900 to 1000 degrees Celsius (° C.). The commercial high-temperature catalytic alumina (Al₂O₃) materials for automobile emission control are roughly divided into two classes, one of which is the γ-phase and δ-phase alumina-based substrates, and the other one is δ-phase and θ-phase alumina-based substrates. Typically, during the catalysis reaction proceeds, the temperature usually reaches 800° C., and more recently reaches 1000° C. to 1100° C. for meeting the new State levels.

U.S. patent application No. 20040043898 discloses a catalyst carrying a catalyst material containing an alkaline metal and/or an alkaline earth metal on a carrier and used as an NOₓ trap catalyst for purifying automobile exhaust gas and the like comprises alumina incorporated into the carrier and/or placed between the carrier and the catalyst material, thereby suppressing the deterioration of the carrier caused by the metals such as Li, Na, K and Ca to be used as an alkaline metal and/or an alkaline earth metal and enabling it to be used for a extended period of time.

U.S. patent Publication No. 6,846,466 discloses a catalyst for purifying an exhaust gas, which includes an upstream side catalyst and a downstream side catalyst. The upstream side catalyst is disposed on an upstream side with respect to an exhaust gas flow, and the downstream side catalyst is disposed on a downstream side with respect thereto. The upstream side catalyst includes a first loading layer, being composed of an alumina containing Ba and La at least, and a first noble metal, being held by the first loading layer and being at least one member selected from the group consisting of Pd, Pd and Rh and Pd and Pt. Alternatively, in addition to the aluminum, the first loading layer can be composed of Ce, a solid solution of Ce and Zr and a solid solution of Ce, Zr and Y in an amount as less as possible. The downstream side catalyst includes a second loading layer, being composed of at least one member selected from the group consisting of an alumina containing La, Ce, a solid solution of Ce and Zr and a solid solution of Ce, Zr and Y, and a second noble metal, being held by the second loading layer and being composed of at least one member selected from the group consisting of Pt, Pd and Rh.

U.S. patent Publication No. 6,623,716 discloses an exhaust gas purifying catalyst for purifying exhaust gas discharged from an automotive internal combustion engine. The exhaust gas purifying catalyst comprises at least one noble metal selected from the group consisting of platinum, palladium and rhodium; and boehmite alumina serving as a base material. In this exhaust gas purifying catalyst, nitrogen oxides in exhaust gas from the engine is trapped to the exhaust gas purifying catalyst when exhaust gas is in a lean region and is reduced into nitrogen by the exhaust gas purifying catalyst when exhaust gas is in a stoichiometric region or a rich region.

U.S. patent Publication No. 5,439,865 discloses a catalyst for exhaust gas purification, which is hereby incorporated by reference. The catalyst for exhaust gas purification comprises a heat-resistant inorganic monolith carrier and a catalyst layer loaded thereon. The catalyst layer includes a catalyst composition containing at least one noble metal selected from Pt, Pd and Rh, as an active catalyst component, and active alumina. The catalyst composition has a specific surface area of at least 50 m²/g and a porosity of at least 50%. This catalyst for exhaust gas purification contains noble metal(s) in a well dispersed state, has excellent high-temperature durability, and is low in thermal deterioration of catalyst performance. Hence, the catalyst can be suitably used as a converter installed in engine manifolds of gasoline engine automobiles, or as a heater having improved purification ability for the exhaust gases emitted from automobiles during their cold start.

U.S. patent Publication No. 4,780,447 discloses a catalyst, which is capable of controlling not only HC, CO and NOₓ, but also H₂S emission from the tail pipe of catalytic converter-equipped automobiles, which is hereby incorporated by reference. The catalyst is made of noble metals promoted with ceria-rich rare earth oxides, preferably doubly promoted along with alkali metal oxides, and oxides of nickel and/or iron as an H₂S gettering ingredient. The oxides of nickel and/or iron are present in an H₂S gettering effective amount and in an amount up to 10 wt %. The alumina support can have additionally from 0 to 20% SiO₂ present.

However, the commercial catalyst substrates cannot be used under such high temperatures for a long time. The reason is mainly that crystallite growth of the alumina transition phases occurs at such high temperatures, changing the transition alumina phases such that the specific surface area of the alumina substrate decreases rapidly. As the catalysis area for the exhaust gases per unit time is decreased, the catalyst substrate suffers a substantial loss of its catalyzing function, followed by the shortened lifetime of the converter.

Accordingly, as for the catalytic converter of the car, there is a need for an alumina carrier material capable of maintaining its high specific surface area when suffering high temperatures for a long time, so as to satisfy the further requirement of the new generation.

### SUMMARY OF THE INVENTION

It is an aspect of the present invention to provide a composite alumina powder and a method for producing the same, which utilizes multi-phase alumina mixed powders for raising the temperature of phase transformation, making it capable of maintaining its high specific surface area when suffering high temperatures for a long time. Therefore, the composite alumina powder of the present invention applied as a high-temperature catalytic material, provides high specific surface area required of the catalysis, prolongs its lifetime, and especially reduces the amounts of noble metals used as well if it is needed, resulting in great reduction of the process cost.

According to the aforementioned aspect of the present invention, there is provided a composite alumina powder, which is suitable for a long-term usage under a higher temperature environment of 700° C. to 1000° C. and is maintained at a specific surface area ranging from 60 to 100 m²/g. The composite alumina powder comprises an α-phase alumina powder ranging from less than (<) 1 to 10% by weight, a second-phase alumina powder ranging from 40 to 98% by weight and a third-phase alumina powder ranging from 1 to 20% by weight. A particle size of the aforementioned α-phase alumina powder is in a range from 50 to 200 nanometers (nm). The second-phase alumina powder is, for example, a θ-phase alumina powder, δ-phase alumina powder or γ-phase alumina powder. The third-phase alumina powder is, for example, κ-phase alumina powder or x-phase alumina powder.

Preferably, when the second-phase alumina powder is the θ-phase alumina powder, the second-phase alumina powder further comprises the δ-phase alumina powder in a preferred amount ranging from 20 to 40% by weight in the composite alumina powder.

Besides, according to the aforementioned aspect of the present invention, there is further provided a method for producing a composite alumina powder. An aluminum salt, such as an organic aluminum salt or an inorganic aluminum salt, is firstly provided. Then, the composite alumina powder is formed, in which the composite alumina powder is mixed with multi-phase alumina powders and comprises an α-phase alumina powder ranging from <1 to 10% by weight, a second-phase alumina powder ranging from 40 to 98% by weight and a third-phase alumina powder ranging from 1 to 20% by weight. A particle size of the aforementioned α-phase alumina powder is in a range from 50 to 200 nm. The second-phase alumina powder is, for example, a θ-phase alumina powder, δ-phase alumina powder or γ-phase alumina powder. The third-phase alumina powder is, for example, κ-phase alumina powder or x-phase alumina powder.

The composite alumina powder and the method for producing the same utilize multi-phase alumina mixed powders for raising the temperature of phase transformation, making it capable of maintaining its high specific surface area when suffering higher temperatures for a long time. Therefore, as the composite alumina powder of the present invention is applied as a high-temperature catalytic material, it provides the high specific surface area required of the catalysis and prolongs its lifetime.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 depicts an XRD pattern of the composite alumina powder according to EXAMPLE 1 of the present invention;

FIG. 2 depicts a diagram of the specific surface area change of the composite alumina powder according to EXAMPLE 1 of the present invention; and

FIG. 3 depicts an XRD pattern of the composite alumina powder after being used at high temperatures according to EXAMPLE 1 of the present invention.

### DETAILED DESCRIPTION OF THE PREFERRED EMBODIMENTS

The present invention provides a composite alumina powder and a method for producing the same, which utilize multi-phase alumina mixed powders for raising the temperature of phase transformation, capable of maintaining its high specific surface area when suffering higher temperatures for a long time, so as to be applied as a high-temperature catalytic material. Hereinafter, the composite alumina powder and the method for producing the same of the present invention are more explicitly and completely clarified in the following description.

In an exemplary embodiment of the present invention, multi-phase alumina powders are firstly provided, in which the multi-phase alumina powders comprise an α-phase alumina powder ranging from <1 to 10% by weight, a second-phase alumina powder ranging from 40 to 98% by weight and a third-phase alumina powder ranging from 1 to 20% by weight. A particle size of the aforementioned α-phase alumina powder is in a range from 50 to 200 nm. The second-phase alumina powder is, for example, a θ-phase alumina powder, δ-phase alumina powder or γ-phase alumina powder. The third-phase alumina powder is, for example, a κ-phase alumina powder or x-phase alumina powder. However, it is noted that the composite alumina powder in the present invention is synonymous with the multi-phase alumina powders herein.

Specifically, in an exemplary embodiment of the present invention, the aforementioned multi-phase alumina powders with a predetermined ratio are obtained from a starting material, for example, gibbsite, boehmite or any mixture thereof, followed by a high temperature treatment under a temperature ranging from 500 to 1100° C. for 1 to 3 hours, for example. Alternatively, the multi-phase alumina powders are mixed with alumina powders having various transition phases in the predetermined ratio. Consequently, with respect to the requirement of components or formulas, the multi-phase alumina powders of the present invention are more flexible than those of the prior art.

The characteristic of the present invention is based on the formation the α-phase alumina related to the critical crystallite size of the δ-phase (or κ-phase) alumina during the phase transformation. When the crystallite does not reach the critical crystallite size, the phase transformation rarely occurs. Moreover, the coalescence reaction is hard to occur between the different alumina phases, for example, between the θ-phase alumina and the α-phase alumina, so the growth of the θ-phase alumina can be restrained in the presence of the α-phase alumina during the phase transformation. Consequently, the present invention utilizes the coexistence of the κ-phase, θ-phase and α-phase alumina for hindering crystallite growth of each other, resulting in raising the temperature of phase transformation and making it hard to form the α-phase alumina and thus difficult to reduce the surface area of the whole alumina powder system. Therefore, the composite alumina powder mixed with multi-phase alumina powders of the present invention is still maintained at a high specific surface area.

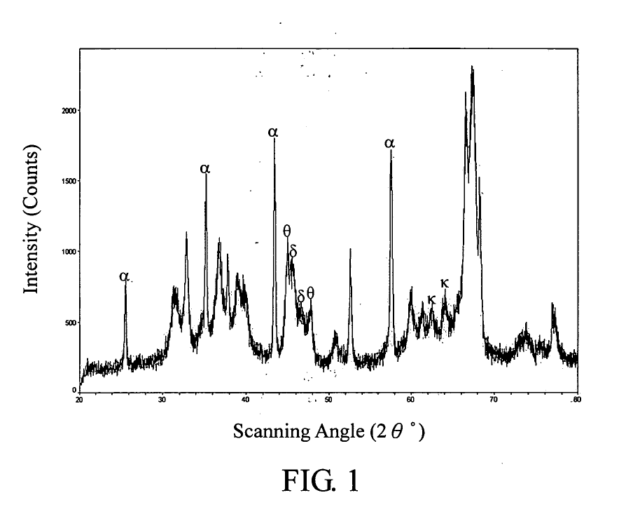

Hereinafter, the composite alumina powder and the method for producing the same of the present invention are more explicitly clarified in following preferred embodiments, when taken in conjunction with FIGS. 1 to 3. However, the embodiments are merely given to illustrate various applications of the invention rather than to be interpreted as limiting the scope of the appended claims.

### EXAMPLE 1

The multi-phase alumina powders of EXAMPLE 1 of the present invention are ground in a wet manner for 24 hours and followed by measuring the specific surface area of the multi-phase alumina powders of EXAMPLE 1, which uses the Gemini 2360 specific surface area analyzer manufactured by Micromeritics Instrument Corporation (US), according to the Brunauer Emmett Teller (BET) method. The initial specific surface area is 110 m²/g.

In addition, the phase identification of the multi-phase alumina powders of EXAMPLE 1 of the present invention is further examined by using the Miniflex desktop X-ray diffraction (XRD) system manufactured by Rigaku International Corporation, the scanning speed of which is 4° per minute, and the scanning angle of which is from 20° to 80°. Reference is made to FIG. 1, which depicts an XRD pattern of the composite alumina powder according to EXAMPLE 1 of the present invention, wherein the vertical axis refers to the intensity of X-rays, and the horizontal axis refers to the scanning angle (20°). In the result of the phase identification in FIG. 1, the multi-phase alumina powders of EXAMPLE 1 are substantially mixed with α-phase alumina powder, θ-phase alumina powder, δ-phase alumina powder and κ-phase alumina powder. After a reexamined analysis of additional XRD phase identification, the amounts of α-phase alumina powder, θ-phase alumina powder, δ-phase alumina powder and κ-phase alumina powder are about 7 percent, about 60 percent, about 25 percent and about 8 percent by weight, respectively.

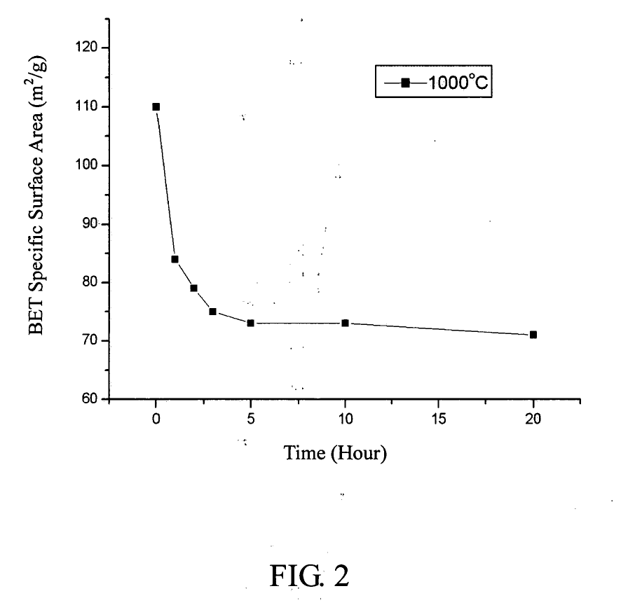

After the above analyses, the multi-phase alumina powders of EXAMPLE 1 are subject to a test for long-term usage, which keeps the multi-phase alumina powders under a high temperature environment of 1000° C. for varying time. Reference is made to FIG. 2, which depicts a diagram of the specific surface area change of the composite alumina powder according to EXAMPLE 1 of the present invention, wherein the vertical axis refers to the BET specific surface area (m²/g), and the horizontal axis refers to the time (in hours). In FIG. 2, the specific surface area of the multi-phase alumina powders of EXAMPLE 1 is initially slightly decreased under the high temperature environment; however, after 5 to 10 hours, the specific surface area is consistently maintained at approximately 73 m²/g, and after the high temperature treatment is kept for 20 hours, the specific surface area is still maintained at about 72 m²/g. That is to say, the composite alumina powder of EXAMPLE 1 of the present invention is still maintained at a high specific surface area under the high temperature environment.

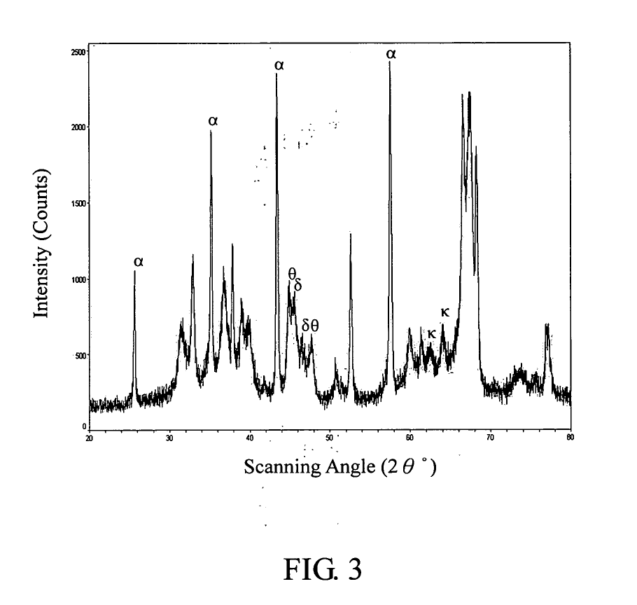

Moreover, after the composite alumina powder of EXAMPLE 1 is used under the high temperature environment, the amounts of various transition phases are further evaluated by the XRD. Reference is made to FIG. 3, which depicts an XRD pattern of the composite alumina powder after being used under a high temperature environment according to EXAMPLE 1 of the present invention, wherein the vertical axis refers to the intensity of X-rays, and the horizontal axis refers to the scanning angle (20°). In the result of the phase identification in FIG. 3, after the composite alumina powder of EXAMPLE 1 is used under the high temperature environment, the amounts of α-phase alumina powder, θ-phase alumina powder, δ-phase alumina powder and κ-phase alumina powder in the composite alumina powder are changed to be about 12 percent, about 60 percent, about 20 percent and about 8 percent by weight, respectively.

### EXAMPLE 2

Gibbsite and boehmite serve as starting materials, followed by a high temperature treatment of approximately 1050° C. to form the multi-phase alumina powders of EXAMPLE 2. Next, after being ground in the wet manner for 24 hours, the specific surface area of the multi-phase alumina powders of EXAMPLE 2 are measured by using the same specific surface area analyzer as in EXAMPLE 1, according to the BET method. The initial specific surface area is 133 m²/g.

In addition, the phase identification of the multi-phase alumina powders of EXAMPLE 2 of the present invention is further examined by using the XRD system of EXAMPLE 1, the scanning speed of which and the scanning angle of which are also the same as in EXAMPLE 1. After the analysis of the phase identification, the amounts of α-phase alumina powder, θ-phase alumina powder, δ-phase alumina powder and κ-phase alumina powder in the multi-phase alumina powders of EXAMPLE 2 are about 1 percent, about 55 percent, about 38 percent and about 6 percent by weight, respectively.

The multi-phase alumina powders of EXAMPLE 2 are subject to a test for long-term usage, which keeps the multi-phase alumina powders under a high temperature environment of 1000° C. for varying time. The specific surface area of the multi-phase alumina powders of EXAMPLE 2 is initially slightly decreased under the high temperature environment; however, after 5 to 10 hours, the specific surface area is consistently maintained at approximately 75 m²/g, and after the high temperature treatment is kept for 20 hours, the specific surface area is still maintained at approximately 75 m²/g. That is to say, the composite alumina powder of EXAMPLE 2 of the present invention is still maintained at a high specific surface area under the high temperature environment.

### EXAMPLE 3

The multi-phase alumina powders of EXAMPLE 3 of the present invention are ground in a wet manner for 24 hours, and followed by measuring the specific surface area of the multi-phase alumina powders of EXAMPLE 3, which uses the same specific surface area analyzer as in EXAMPLE 1, according to the BET method. The initial specific surface area is 116 m²/g.

In addition, the phase identification of the multi-phase alumina powders of EXAMPLE 3 of the present invention is further examined by using the same XRD system as in EXAMPLE 1, the scanning speed of which and the scanning angle of which are also the same as in EXAMPLE 1. After the analysis of the phase identification, the amounts of α-phase alumina powder, θ-phase alumina powder, δ-phase alumina powder and κ-phase alumina powder in the multi-phase alumina powders of EXAMPLE 3 are about 6 percent, about 50 percent, about 30 percent and about 14 percent by weight, respectively.

The multi-phase alumina powders of EXAMPLE 3 are subject to a test for long-term usage, which keeps the multi-phase alumina powders under a high temperature environment of 1000° C. for varying time. The specific surface area of the multi-phase alumina powders of EXAMPLE 3 is initially slightly decreased under the high temperature environment; however, after 5 to 10 hours, the specific surface area is consistently maintained at approximately 71 m²/g, and after the high temperature treatment is kept for 20 hours, the specific surface area is still maintained at about 70 m²/g. That is to say, the composite alumina powder of EXAMPLE 3 of the present invention is still maintained at a high specific surface area under the high temperature environment.

### EXAMPLE 4

Mixtures of gibbsite and boehmite serve as starting materials, followed by a high temperature treatment of about 550° C. to form the multi-phase alumina powders of EXAMPLE 4. Next, the specific surface area of the multi-phase alumina powders of EXAMPLE 4 are measured by using the same specific surface area analyzer as used in EXAMPLE 1, according to the BET method. The initial specific surface area is 111 m²/g.

In addition, the phase identification of the multi-phase alumina powders of EXAMPLE 4 of the present invention is further examined by using the same XRD system as in EXAMPLE 1, the scanning speed of which and the scanning angle of which are also the same as in EXAMPLE 1. After the analysis of the phase identification, the amounts of α-phase alumina powder, θ-phase alumina powder, δ-phase alumina powder and κ-phase alumina powder in the multi-phase alumina powders of EXAMPLE 4 are about <1 percent, about 43 percent, about 30 percent and about 20 percent by weight, respectively.

The multi-phase alumina powders of EXAMPLE 4 are subject to a test for long-term usage, which keeps the multi-phase alumina powders under a high temperature environment of 1000° C. for various time periods. The specific surface area of the multi-phase alumina powders of EXAMPLE 4 is initially slightly decreased under the high temperature environment; however, after 5 to 10 hours, the specific surface area is consistently maintained at approximately 65 m²/g, and after the high temperature treatment is kept for 20 hours, the specific surface area is slightly increased up to about 66 m²/g. That is to say, the composite alumina powder of EXAMPLE 4 of the present invention still is maintained at a high specific surface area under the high temperature environment.

### EXAMPLE 5

The multi-phase alumina powders of EXAMPLE 5 of the present invention are ground in a wet manner for 24 hours, and followed by measuring the specific surface area of the multi-phase alumina powders of EXAMPLE 5, which uses the same specific surface area analyzer as used in EXAMPLE 1, according to the BET method. The initial specific surface area is 117 m²/g.

In addition, the phase identification of the multi-phase alumina powders of EXAMPLE 5 of the present invention is further examined by using the same XRD system as in EXAMPLE 1, the scanning speed of which and the scanning angle of which are also the same as in EXAMPLE 1. After the analysis of the phase identification, the amounts of α-phase alumina powder, θ-phase alumina powder, δ-phase alumina powder and κ-phase alumina powder in the multi-phase alumina powders of EXAMPLE 5 are about 8 percent, about 60 percent, about 25 percent and about 7 percent by weight, respectively.

The multi-phase alumina powders of EXAMPLE 5 are subject to a test for long-term usage, which keeps the multi-phase alumina powders under a high temperature environment of 1000° C. for varying time. The specific surface area of the multi-phase alumina powders of EXAMPLE 5 is initially slightly decreased under the high temperature environment; however, after 5 to 10 hours, the specific surface area is consistently maintained at approximately 62 m²/g. And after the high temperature treatment is kept for 20 hours, the specific surface area is still maintained at about 61 m²/g. That is to say, the composite alumina powder of EXAMPLE 5 of the present invention is still maintained at a high specific surface area under the high temperature environment.

The results of EXAMPLES 1 to 5 are summarized in TAB. 1:

TABLE 1

| | | | | | Specific Surface Area (m²/g) | | |
|---|---|---|---|---|---|---|---|
| EXAM- | Components (percent by weight) | | | | | 10 | 20 |
| PLES | α | θ | δ | κ | Initiation | hours | hours |
| 1 | 7 | 60 | 25 | 8 | 110 | 73 | 72 |
| 2 | 1 | 55 | 38 | 6 | 133 | 75 | 75 |
| 3 | 6 | 50 | 30 | 14 | 116 | 71 | 70 |
| 4 | <1 | >49 | 30 | 20 | 111 | 65 | 66 |
| 5 | 8 | 60 | 25 | 7 | 117 | 62 | 61 |

In brief, the composite alumina powder and the method for producing the same are characterized by mixing multi-phase alumina powders, leading the crystallite growth of the resultant composite alumina powder to be restrained for raising the temperature of phase transformation, so as to maintain its high specific surface area when suffering high temperatures for a long-term use. Moreover, the gibbsite and the boehmite serve as starting materials of the composite alumina powder of the present invention, and the composition of the predetermined ratio can be obtained by using the high temperature treatment. Consequently, with respect to the requirement of components or formulas, the composite alumina powder of the present invention is more flexible than the prior art, and alternatively, it can be further obtained by mixing the multi-phase alumina powders with various ratios, thereby reducing the process, energy source and cost. Furthermore, the composite alumina powder of the present invention is still maintained at a high specific surface area ranging from 60 m²/g to 100 m²/g after being used at high temperature for a long time. Therefore, the composite alumina powder of the present invention has overcome various disadvantages caused by the quickly decreased specific surface area due to the prior alumina catalytic material used in a high temperature environment for a long time, and the prior alumina catalytic material is far from this above advantage provided by the present invention. As the aforementioned description, the composite alumina powder of the present invention can replace the prior alumina catalytic material, so as to be applied as an excellent high-temperature catalytic material or catalyst monolith that is suitable for a higher temperature and a wider temperature range.

According to the aforementioned preferred embodiments, one advantage of the composite alumina powder and the method for producing the same of the present invention utilizes multi-phase alumina mixed powders for raising the temperature of phase transformation and capable of maintaining its high specific surface area when suffering high temperatures for a long time. Therefore, as the composite alumina powder of the present invention is applied as a high temperature catalytic material, it provides high specific surface area required of the catalysis, prolongs its lifetime, and is easy to obtain the starting materials, resulting in great reduction of the process time, energy and cost. As is understood by a person skilled in the art, the foregoing preferred embodiments of the present invention are illustrated of the present invention rather than limiting of the present invention. It is intended to cover various modifications and similar arrangements included within the spirit and scope of the appended claims. Therefore, the scope of that should be accorded the broadest interpretation so as to encompass all such modifications and similar structure.

What is claimed is:

1. A composite alumina powder, which is suitable for a long-term usage under a high temperature of 700 degrees Celsius to 1000 degrees Celsius and is maintained at a specific surface area ranging from 60 m²/g to 100 m²/g, the composite alumina powder comprising:
an α-phase alumina powder ranging from <1% to 10% by weight, wherein a particle size of the α-phase alumina powder is in a range from 50 nanometers (nm) to 200 nm;
a second-phase alumina powder ranging from 40% to 98% by weight, wherein the second-phase alumina powder is selected from the group consisting of a θ-phase alumina powder, δ-phase alumina powder, γ-phase alumina powder and any combination thereof; and
a third-phase alumina powder ranging from 1% to 20% by weight, wherein the third-phase alumina powder is selected from the group consisting of κ-phase alumina powder, x-phase alumina powder and any combination thereof.

2. The composite alumina powder according to claim 1, wherein the second-phase alumina powder is the θ-phase alumina powder, the second-phase alumina powder further comprises the δ-phase alumina powder in an amount ranging from 20% to 40% by weight in the composite alumina powder.

3. A catalytic material, which is suitable for a long-term usage under a high temperature of 700 degrees Celsius to 1000 degrees Celsius and is maintained at a specific surface area ranging from 60 m²/g to 100 m²/g, the catalytic material comprising:
an α-phase alumina powder ranging from <1% to 10% by weight, wherein a particle size of the α-phase alumina powder is in a range from 50 nm to 200 nm;
a second-phase alumina powder ranging from 40% to 98% by weight, wherein the second-phase alumina powder is selected from the group consisting of a θ-phase alumina powder, δ-phase alumina powder, γ-phase alumina powder and any combination thereof; and
a third-phase alumina powder ranging from <1% to 20% by weight, wherein the third-phase alumina powder is selected from the group consisting of κ-phase alumina powder, x-phase alumina powder and any combination thereof.

4. The catalytic material according to claim 3, wherein the second-phase alumina powder is the θ-phase alumina powder, the second-phase alumina powder further comprises the δ-phase alumina powder in an amount ranging from 20% to 40% by weight in the catalytic material.

5. A method for producing a composite alumina powder that is suitable for a long-term usage under a high temperature of 700 degrees Celsius to 1000 degrees Celsius and is maintained at a specific surface area ranging from 60 m²/g to 100 m²/g, the method comprising:
providing an aluminum salt, wherein the aluminum salt is selected from the group consisting of an organic aluminum salt and an inorganic aluminum salt; and
forming the composite alumina powder, wherein the composite alumina powder is mixed with multi-phase alumina powders and comprises:
an α-phase alumina powder ranging from <1% to 10% by weight, wherein a particle size of the α-phase alumina powder is in a range from 50 nm to 200 nm;
a second-phase alumina powder ranging from 40% to 98% by weight, wherein the second-phase alumina powder is selected from the group consisting of a θ-phase alumina powder, δ-phase alumina powder, γ-phase alumina powder and any combination thereof; and
a third-phase alumina powder ranging from 1% to 20% by weight, wherein the third-phase alumina powder is selected from the group consisting of κ-phase alumina powder, x-phase alumina powder and any combination thereof.

6. The method for producing a composite alumina powder according to claim 5, wherein the second-phase alumina powder is the θ-phase alumina powder, the second-phase alumina powder further comprises the δ-phase alumina powder in an amount ranging from 20% to 40% by weight in the multi-phase alumina mixed powders.

7. The method for producing a composite alumina powder according to claim 5, wherein the step of forming the multi-phase alumina mixed powders is a step of a high temperature treatment.

8. The method for producing a composite alumina powder according to claim 7, wherein the high temperature treatment is carried out under a temperature in a range of 500 degrees Celsius to 1100 degrees Celsius for 1 to 3 hours.

9. The method for producing a composite alumina powder according to claim 5, wherein the step of forming the multi-phase alumina mixed powders is a mixing step.

10. The method for producing a composite alumina powder according to claim 5, wherein the aluminum salt is gibbsite, boehmite or any mixture thereof.

11. A method for producing a catalytic material that is suitable for a long-term usage under a high temperature of 700 degrees Celsius to 1000 degrees Celsius and is maintained at a specific surface area ranging from 60 m²/g to 100 m²/g, the method comprising:
providing an aluminum salt, wherein the aluminum salt is selected from the group consisting of an organic aluminum salt and an inorganic aluminum salt; and
forming the catalytic material, wherein the catalytic material is mixed with multi-phase alumina powders and comprises:
an α-phase alumina powder ranging from <1% to 10% by weight, wherein a particle size of the α-phase alumina powder is in a range from 50 nm to 200 nm;
a second-phase alumina powder ranging from 40% to 98% by weight, wherein the second-phase alumina powder is selected from the group consisting of a θ-phase alumina powder, δ-phase alumina powder, γ-phase alumina powder and any combination thereof; and
a third-phase alumina powder ranging from 1% to 20% by weight, wherein the third-phase alumina powder is selected from the group consisting of κ-phase alumina powder, x-phase alumina powder and any combination thereof.

12. The method for producing a catalytic material according to claim 11, wherein the second-phase alumina powder is the θ-phase alumina powder, the second-phase alumina powder further comprises the δ-phase alumina powder in an amount ranging from 20% to 40% by weight in the catalytic material.

13. The method for producing a catalytic material according to claim 1 1, wherein the step of forming the catalytic material is a step of a high temperature treatment.

14. The method for producing a catalytic material according to claim 13, wherein the high temperature treatment is carried out under a temperature in a range of 500 degrees Celsius to 1100 degrees Celsius for 1 to 3 hours.

15. The method for producing a catalytic material according to claim 11, wherein the step of forming the catalytic material is a mixing step.

16. The method for producing a catalytic material according to claim 11, wherein the aluminum salt is gibbsite, boehmite or any mixture thereof.
